(19) United States
(12) Patent Application Publication
(10) Pub. No.: US 2024/0266681 A1
(43) Pub. Date: Aug. 8, 2024

(54) RECHARGEABLE BATTERY PACK

(71) Applicant: SAMSUNG SDI CO., LTD., Yongin-si (KR)

(72) Inventors: Soodeok MOON, Yongin-si (KR); Taeho JI, Yongin-si (KR); Soomin AHN, Yongin-si (KR)

(21) Appl. No.: 18/529,270

(22) Filed: Dec. 5, 2023

(30) Foreign Application Priority Data
Feb. 2, 2023 (KR) 10-2023-0014491

(51) Int. Cl. H01M 50/503; H01M 50/209; H01M 50/507; H01M 50/514; H01M 50/548

(52) U.S. Cl. CPC H01M 50/503; H01M 50/209; H01M 50/507; H01M 50/514; H01M 50/548

(57) ABSTRACT

A rechargeable battery pack includes: a plurality of unit battery cells; a case having an insertion space, the plurality of unit battery cells being accommodated in the insertion space; and a plurality of battery holders installed inside the case and electrically connecting the plurality of unit battery cells to each other.

### CROSS-REFERENCE TO RELATED APPLICATION

This application claims priority to and the benefit of Korean Patent Application No. 10-2023-0014491, filed in the Korean Intellectual Property Office on Feb. 2, 2023, the entire content of which is incorporated herein by reference.

### BACKGROUND

### 1. Field

Aspects of embodiments of the present disclosure relate to a rechargeable battery pack.

### 2. Description of the Related Art

A rechargeable (or secondary) battery is a battery that is designed to be repeatedly charged and discharged, unlike a primary battery. A small-capacity rechargeable battery may be used in a small, portable electronic device, such as a mobile phone, a laptop computer, or a camcorder. A large-capacity and high-density rechargeable battery is often used as a power source for driving a motor of a hybrid vehicle or an electric vehicle or as an energy storage device for the hybrid vehicle or the electric vehicle.

A rechargeable battery generally includes an electrode assembly for charging and discharging a current, a case accommodating the electrode assembly and an electrolyte, and an electrode terminal connected to the electrode assembly to draw the electrode assembly out to the outside of the case. The electrode assembly may be a jelly roll type formed by winding an electrode and a separator together.

In a conventional rechargeable battery pack, a plurality of unit battery cells are connected, by welding, to an electrode terminal during a process of manufacturing the rechargeable battery pack.

1 However, in a process of welding a battery cell to the electrode terminal, deterioration damage due to welding heat occurs, causing durability to be lowered due to heat damage.

### SUMMARY

An embodiment of the present disclosure provides a rechargeable battery pack which avoids or mitigates deterioration damage due to welding by connecting an electrode terminal in a form of a cartridge without welding.

A rechargeable battery pack, according to an embodiment of the present disclosure, includes: a plurality of unit battery cells; a case having an insertion space, the plurality of unit battery cells being accommodated in the insertion space; and a plurality of battery holders installed inside the case and electrically connecting the plurality of unit battery cells to each other.

The plurality of battery holders may be installed inside the case along a first direction.

The battery holder may include: a first holder that connects the plurality of unit battery cells to each other in the first direction in the insertion space of the case; and a second holder that connects the plurality of unit battery cells in a second direction orthogonal to the first direction at one side of the case.

Each of the first holders may include: a plurality of first holder bodies spaced apart from each other at equal intervals, the plurality of first holder bodies may each have a first insertion portion extending in a longitudinal direction; and a plurality of first cell bus bars respectively in the plurality of first insertion portions. Electrode terminals of the plurality of unit battery cells may be connected to ones of the first cell bus bars at opposite sides of the plurality of first holder bodies.

The second holder may include: a second holder body installed at one side of an inner wall surface of the case and having a plurality of second insertion portions extending in a length direction; and a plurality of second cell bus bars respectively in the plurality of second insertion portions and electrically connected to different electrode terminals of the plurality of unit battery cells.

Each of the first cell bus bars may have an elastic protrusion protruding from a surface thereof and electrically connected to the electrode terminal of one of the plurality of unit battery cells.

Each of the plurality of second cell bus bars may have an elastic protrusion protruding from a surface thereof and electrically connected to the electrode terminal of one of the plurality of unit battery cells.

Each of the plurality of first cell bus bars may further include a first elastic connecting plate protruding at opposite sides of corresponding one of the first cell bus bars and electrically connected to the electrode terminal of one of the unit battery cells in a pressurized state.

The first elastic connecting plate may include: a first elastic piece protruding from one side of the corresponding first cell bus bar; and a second elastic piece protruding from the other side of corresponding the first cell bus bar.

The elastic protrusion may protrude from a surface of the first elastic connecting plate.

Each of the second holder may further include a second elastic connecting plate installed at one side of the second cell bus bar and electrically connected to different electrode terminals of ones of the plurality of unit battery cells in a pressurized state.

The second elastic connecting plate may include: a first connecting plate electrically connected to an electrode terminal of one unit battery cell from among the plurality of unit battery cells; and a second connecting plate electrically connected to an electrode terminal of another unit battery cell from among the plurality of unit battery cells.

The elastic protrusion may protrude from the surface of the first elastic connecting plate and from a surface of the second elastic connecting plate.

At least one of the battery holders may include a guide rib protruding from a side surface of the at least one of the battery holders and may be configured to guide a position at where the unit battery cell is inserted into the at least one of the battery holders.

At least one of the first elastic piece and the second elastic piece may have a length that is shorter than a height of the corresponding first cell bus bar such that a portion of the first cell bus bar is exposed to the outside.

The first elastic piece and the second elastic piece may have the same length in a vertical direction at opposite sides of the corresponding first cell bus bar.

Each of the first elastic piece and the second elastic piece may have a length that is shorter than the height of the cell bus bar such that portions of surfaces of the opposite sides of the cell bus bar are exposed to the outside.

The guide rib may include: a first rib protruding at an exposed portion of the cell bus bar and on one side surface of the cell bus bar; and a second rib protruding at an exposed portion of the cell bus bar and on the other side surface of the cell bus bar.

The first rib and the second rib may protrude at the same height position at the opposite sides of the corresponding first cell bus bar.

The electrode terminals of the unit battery cell may include: a first electrode terminal protruding at an eccentric position from one side of the unit battery cell; and a second electrode terminal protruding at an eccentric position from another side of the unit battery cell. The first electrode terminal and the second electrode terminal may protrude at the same height position on both sides of the unit battery cell.

One of the first elastic piece and the second elastic piece may have a length that is shorter than a height of the first cell bus bar such that a portion of the corresponding first cell bus bar is exposed to the outside.

The first elastic piece and the second elastic piece may have different lengths in a vertical direction at opposite sides of the corresponding first cell bus bar.

One of the first elastic piece and the second elastic piece may have the length that is shorter than the height of the first cell bus bar such that a portion of one side of the first cell bus bar is exposed to the outside.

A single guide rib may protrude at an exposed portion of the first cell bus bar and on one side surface of the first cell bus bar.

The electrode terminals of the unit battery cell may include: a first electrode terminal protruding at an eccentric position from one side of the unit battery cell; and a second electrode terminal protruding at a central position from another side of the unit battery cell. The first electrode terminal and the second electrode terminal may respectively protrude at different height positions on both sides of the unit battery cell.

The battery holder may further include a connection terminal protruding in a width direction of the unit battery cell.

The battery holder may further include a third holder installed at both sides opposite to inner wall surfaces of the case and electrically connecting the plurality of unit battery cells.

The third holder may include: a third holder body installed at opposite sides of the inner wall surfaces of the case and having a plurality of third insertion portions therein; and a plurality of third cell bus bars respectively in the plurality of third insertion portions of the third holder body and connected to different electrode terminals of the plurality of unit battery cells.

The third cell bus bar may include an elastic protrusion protruding from a surface thereof and electrically connected to the electrode terminal of one of the plurality of unit battery cells.

The rechargeable battery pack may further include an electrical conductivity filler between the battery holder and the plurality of unit battery cells.

The electrical conductivity filler may be a solder or a conductive glue film.

According to embodiments of the present disclosure, a plurality of unit battery cells are electrically connected to each other in a cartridge form without welding by a plurality of first holders and a second holder. Thus, durability is improved because deterioration damage caused by welding in a process of connecting electrode terminals to avoided.

### BRIEF DESCRIPTION OF THE DRAWINGS

FIG. 1 is a perspective view schematically showing a rechargeable battery pack according to a first embodiment of the present disclosure.

FIG. 2 is a perspective view schematically showing the rechargeable battery pack shown in FIG. 1 in a state in which a unit battery cell (or a single battery cell) is removed.

FIG. 3 is a perspective view schematically showing a first holder according to the first embodiment of the present disclosure.

FIG. 4 is a perspective view schematically showing a first cell bus bar inserted into a first holder body forming the first holder shown in FIG. 3.

FIG. 5 is a perspective view schematically showing a second holder according to the first embodiment of the present disclosure.

FIG. 6 is a perspective view schematically showing a second cell bus bar inserted into a second holder body forming the second holder shown in FIG. 5.

FIG. 7 is a plane view schematically illustrating a state in which a plurality of unit battery cells of the rechargeable battery pack according to the first embodiment of the present disclosure are connected in series by a battery holder.

FIG. 8 is a plane view schematically showing a state in which a plurality of unit battery cells of a rechargeable battery pack according to a second embodiment of the present disclosure are connected in parallel by a battery holder.

FIG. 9 is a perspective view schematically showing a state in which a first elastic connecting plate protrudes at a first holder of a battery holder of a rechargeable battery pack according to a third embodiment of the present disclosure.

FIG. 10 is a side view schematically showing a state in which the first elastic connecting plate protrudes at a side surface of the first holder shown in FIG. 9.

FIG. 11 is a side view schematically illustrating a state in which a unit battery cell (or a single battery cell) is inserted between a plurality of first holders according to the third embodiment of the present disclosure.

FIG. 12 is a side view schematically showing a state in which the unit battery cell shown in FIG. 11 is inserted between the plurality of first holders.

FIG. 13 is a view schematically showing a state in which a second elastic connecting plate protrudes at a second holder of the battery holder of the rechargeable battery pack according to the third embodiment of the present disclosure.

FIG. 14 is a side view schematically showing a state in which the second elastic connecting plate protrudes at a side surface of the second holder shown in FIG. 13.

FIG. 15 is a side view schematically illustrating a state in which a guide rib protrudes at a battery holder of a rechargeable battery pack according to a fourth embodiment of the present disclosure.

FIG. 16 is a side view schematically illustrating a state in which a guide rib protrudes at a battery holder of a rechargeable battery pack according to a fifth embodiment of the present disclosure.

FIG. 17 is a view schematically showing a state in which an electrical conductivity filler is applied between a battery holder and an electrode terminal according to a sixth embodiment of the present disclosure.

FIG. 18 is a perspective view schematically showing a rechargeable battery pack according to the sixth embodiment of the present disclosure.

FIG. 19 is a perspective view schematically showing a state in which a unit battery cell is removed from the rechargeable battery pack shown in FIG. 18.

### DETAILED DESCRIPTION

The present disclosure will be described more fully hereinafter with reference to the accompanying drawings, in which embodiments of the present disclosure are shown. As those skilled in the art would realize, the described embodiments may be modified in various different ways, all without departing from the scope of the present disclosure. Thus, the drawings and description are to be regarded as illustrative in nature and not restrictive.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

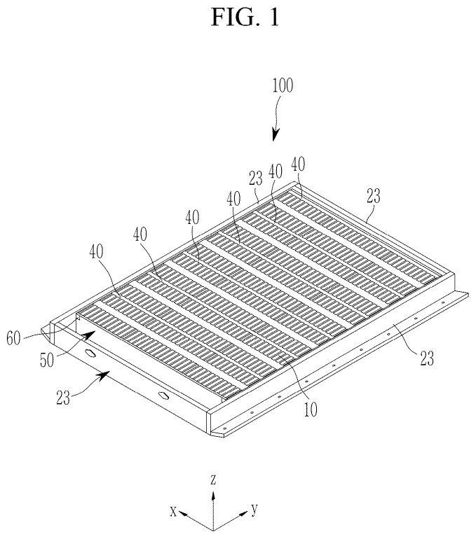

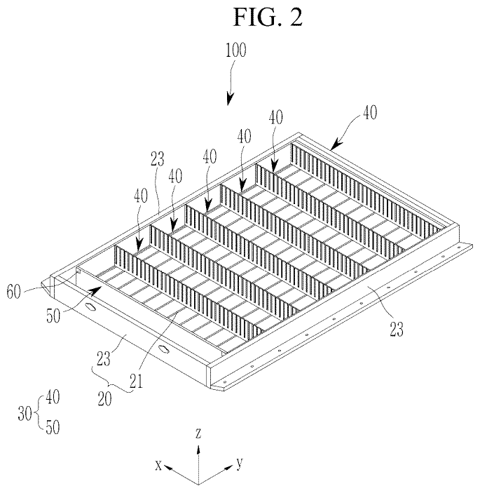

FIG. 1 is a perspective view schematically showing a rechargeable battery pack according to a first embodiment of the present disclosure, and FIG. 2 is a perspective view schematically showing the rechargeable battery pack shown in FIG. 1 in a state in which a unit battery cell (or a single battery cell) is removed therefrom.

As shown in FIGS. 1 and 2, the rechargeable battery pack 100, according to the first embodiment of the present disclosure, includes a plurality of unit battery cells 10, a case 20 having an insertion space into which the plurality of unit battery cells 10 are inserted (or accommodated), and a plurality of battery holders 30 installed inside the case 20 to electrically connect the plurality of unit battery cells 10 to each other.

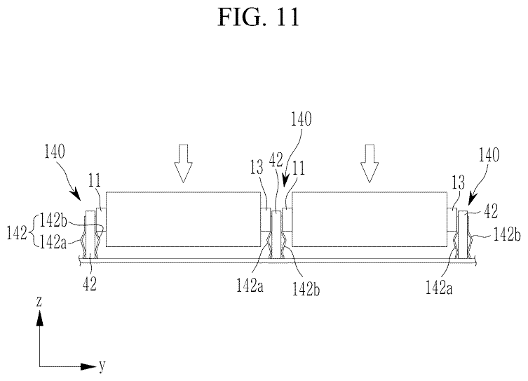

The unit battery cell 10 may be a battery having a prismatic cross-section and may be a conventional rechargeable battery that is designed to be repeatedly charged and discharged. Each unit battery cell 10 may have electrode terminals 11 and 13 (see, e.g., FIG. 11). In some embodiments, the electrode terminals 11 and 13 may be at opposite ends of the unit battery cell 10. The unit battery cells 10 may form (or may be arranged in) a plurality of rows and columns inside the case 20 to be inserted into the battery holder 30 so that the unit battery cells 10 are supported by the battery holder 30.

The case 20 may include a bottom plate 21 supporting the unit battery cell 10 and a side surface portion 23 installed at an edge of the bottom plate 21 to support the unit battery cell 10.

The side surface portion 23 may be integrally combined with the bottom plate 21. In other embodiments, however, the side surface portion 23 may be detachably combined with the bottom plate 21 by a bolt fastening method, a method in which a protrusion is inserted into a groove, or the like.

The case 20 may form a rectangular parallelepiped-shape insertion space into which the plurality of unit battery cells 10 are inserted.

The plurality of unit battery cells 10 may be installed in a state in which the plurality of unit battery cells 10 are electrically connected to each other by the battery holder 30 in state in which the plurality of unit battery cells 10 is inserted inside the case 20.

The plurality of battery holders 30 may be installed along a first direction inside the case 20 to electrically connect the plurality of unit battery cells 10 to each other.

The battery holder 30 may include a first holder 40 for connecting the plurality of unit battery cells 10 to each other in a first direction (e.g., a y-axis direction) in the insertion space of the case 20 and a second holder 50 for connecting the plurality of unit battery cells 10 in a second direction (e.g., an x-axis direction) orthogonal to the first direction at one side of the case 20.

As used herein, the first direction (e.g., the y-axis direction) may be a transverse direction in which a plurality of first holders 40 are disposed. In addition, the second direction (e.g., the x-axis direction) may be a direction orthogonal to the first direction and may be a longitudinal direction in which the plurality of unit battery cells 10 are electrically connected.

The plurality of first holders 40 may be installed within the case 20 in a state in which the plurality of first holders 40 are spaced apart from each other at equal intervals in the first direction (e.g., the y-axis direction) to electrically connect the plurality of unit battery cells 10 to each other.

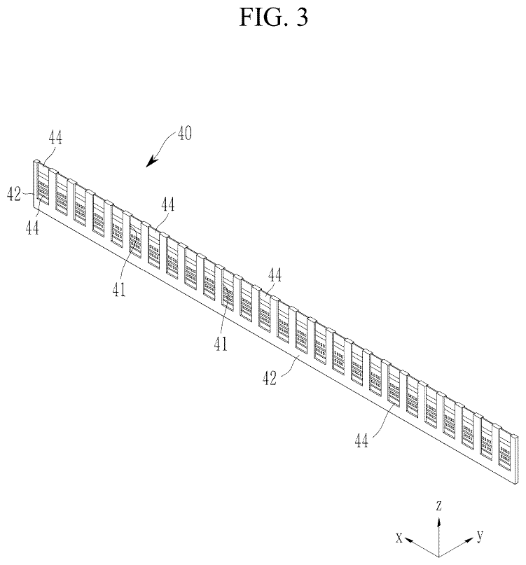

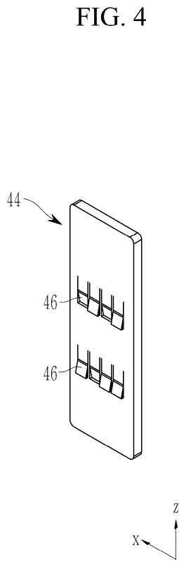

FIG. 3 is a perspective view schematically showing the first holder according to the first embodiment of the present disclosure, and FIG. 4 is a perspective view schematically showing a first cell bus bar inserted into a first holder body forming the first holder shown in FIG. 3.

Referring to FIGS. 3 and 4, the first holder 40 may include first holder bodies 42 having a plurality of first insertion portions 41 formed in the second direction (e.g., the longitudinal direction or the x-axis direction) and installed inside the case 20 in a state in which the first holder bodies 42 are spaced apart from each other at equal intervals and a plurality of first cell bus bars 44 inserted into the plurality of first insertion portions 41 of the first holder body 42 and to which electrode terminals of the unit battery cells 10 are electrically connected at opposite sides of the first holder body 42.

The first holder bodies 42 may be installed within the case 20 along the first direction (e.g., the y-axis direction) at equal intervals between each other, and the first holder body 42 may be formed in a long length (e.g., may be formed to have a longest dimension) in the second direction (e.g., the x-axis direction) orthogonal to the first direction.

In the first holder body 42, the plurality of first insertion portions 41 may be formed in a state of being spaced apart from each other along a length direction.

The first insertion portion 41 may penetrate (or may extend through) the first holder body 42, and the first cell bus bar 44 may be inserted in the first insertion portion 41. Therefore, the electrode terminal may be inserted into the first insertion portion 41 to be electrically connected to the first cell bus bar 44.

The first cell bus bar 44 may electrically connect the plurality of unit battery cells 10 to each other at opposite sides of the first cell bus bar 44 in a state in which the first cell bus bar 44 is inserted into the first insertion portion 41.

Elastic protrusions 46 may protrude on (or may protrude from) a surface of the first cell bus bar 44.

Because the electrode terminal of the unit battery cell 10 is stably in close contact with the elastic protrusion 46, the durability of electrical connection is improved.

As described above, the plurality of unit battery cells 10 may be electrically connected along the first direction (e.g., the y-axis direction) by the first holder 40. In addition, the plurality of unit battery cells 10 may be electrically connected to each other by the second holder 50 at one side of an inner wall surface of the case 20.

The second holder 50 may be installed to electrically connect one sides of the plurality of unit battery cells 10 electrically connected in the first direction (e.g., the y-axis direction) by the first holder 40 to each other in the second direction (e.g., the x-axis direction).

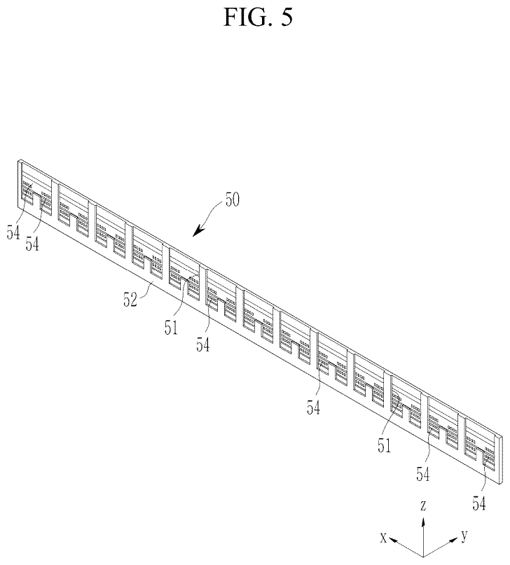

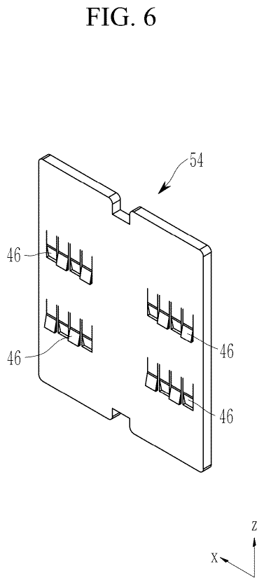

FIG. 5 is a perspective view schematically showing the second holder according to the first embodiment of the present disclosure, and FIG. 6 is a perspective view schematically showing a second cell bus bar inserted into a second holder body forming the second holder shown in FIG. 5.

Referring to FIGS. 5 and 6, the second holder 50 may include a second holder body 52 having a plurality of second insertion portions 51 formed in a length direction and installed at one side of the inner wall surface of the case 20 and a second cell bus bar 54 inserted into the second insertion portion 51 to be electrically connected to different electrode terminals of the plurality of unit battery cells 10.

The second holder body 52 may be installed at the one side of the inner wall surface of the case 20, and the plurality of second insertion portions 51 may be formed spaced apart from each other in a length direction.

The second insertion portion 51 may be formed in a shape of a groove at the second holder body 52, and the second cell bus bar 54 may be inserted in the second insertion portion 51. For example, the electrode terminal may be inserted into the second insertion portion 51 to be electrically connected to the second cell bus bar 54.

The second cell bus bar 54 may be inserted into the second insertion portion 51 to electrically connect electrode terminals formed on one sides of a pair of unit battery cells 10 to each other.

A plurality of elastic protrusions 46 may protrude on (or may protrude from) a surface of the second cell bus bar 54. Therefore, the electrode terminals of the plurality of unit battery cells 10 may be in close contact with the plurality of elasticity protrusions 46 to enable more a stable electrical connection.

In some embodiments, a connection terminal 60 may protrude in a width direction of the unit battery cell 10 in the battery holder 30 (see, e.g., FIGS. 1 and 2).

The connection terminal 60 may protrude on (or may protrude from) a side surface of the battery holder 30 to be electrically connected to any one of the plurality of unit battery cells 10 connected by the battery holder 30.

The connection terminal 60 may protrude at any one of the first holder 40 and the second holder 50 constituting the battery holder 30 and may be electrically connected to an outermost cell of the plurality of unit battery cells 10.

As described above, in the rechargeable battery pack 100 according to the first embodiment of the present disclosure, because the plurality of unit battery cells 10 are electrically connected to each other in a form of a cartridge in a non-welding state (without being welded) by the plurality of first holders 40 and the second holder 50, the durability is improved because deterioration damage caused by welding in a process of connecting the electrode terminals is avoided.

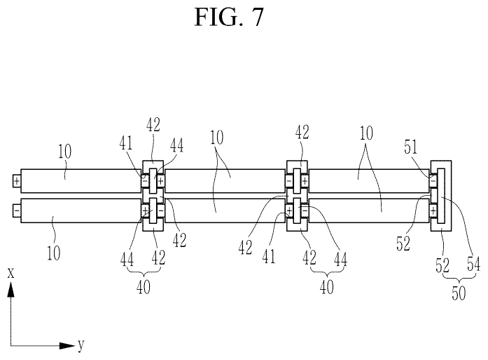

FIG. 7 is a plane view schematically illustrating a state in which the plurality of unit battery cells of the rechargeable battery pack according to the first embodiment of the present disclosure are connected in series by the battery holder.

As shown in FIG. 7, the plurality of unit battery cells 10 may be connected in series with different polarities in the first direction by the first holder(s) 40.

In addition, the plurality of unit battery cells 10 connected in series may be electrically connected in the second direction by the second holder 50.

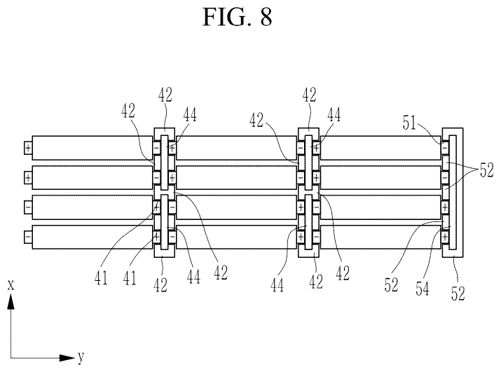

FIG. 8 is a plane view schematically showing a state in which a plurality of unit battery cells of a rechargeable battery pack according to a second embodiment of the present disclosure are connected in parallel by a battery holder.

As shown in FIG. 8, electrode terminals of the same polarity of a pair of unit battery cells 10 may be electrically connected to the first holder 40 to connect the pair of unit battery cells 10 in parallel.

A single first cell bus bar 44 may be inserted into two first insertion portions 41 to be connected to the electrode terminals of two unit battery cells 10.

In addition, the plurality of unit battery cells 10 connected in parallel may be electrically connected in the second direction by the second holder 50. A single second cell bus bar 54 may be inserted into two second insertion portions 51 to be connected to the electrode terminals of four unit battery cells 10.

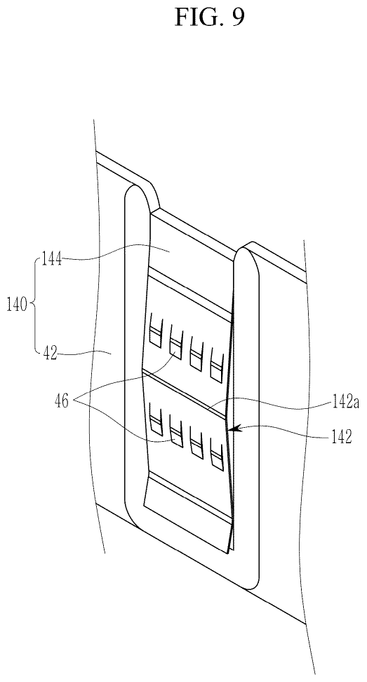

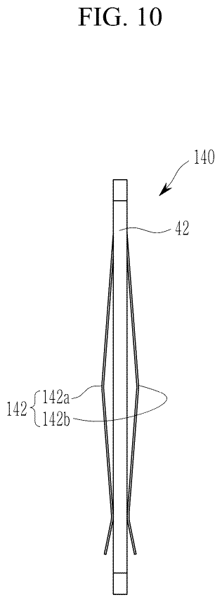

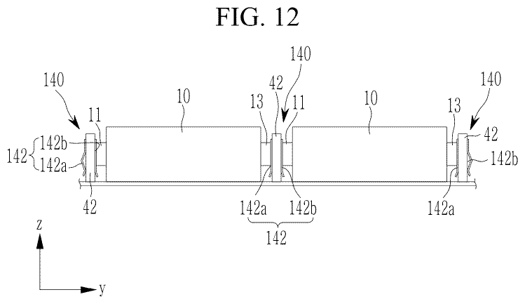

FIG. 9 is a view schematically showing a state in which a first elastic connecting plate protrudes at a first holder of a battery holder of a rechargeable battery pack according to a third embodiment of the present disclosure, FIG. 10 is a side view schematically showing a state in which the first elastic connecting plate protrudes at a side surface of the first holder shown in FIG. 9, FIG. 11 is a side view schematically illustrating a state in which a unit battery cell (or a single battery cell) is inserted between a plurality of first holders according to the third embodiment of the present disclosure, and FIG. 12 is a side view schematically showing a state in which the unit battery cell shown in FIG. 11 is inserted between the plurality of first holders. In the following description, the same reference numerals as those in FIGS. 1 to 8 denote the same or similar member having the same or similar function. Thus, detailed description of elements or components donated by the same reference numerals will be omitted.

As shown in FIGS. 9 to 12, a first holder 140 of the rechargeable battery pack, according to the third embodiment of the present disclosure, may include the first holder body 42 and a first cell bus bar 144 inserted into the first holder body 42. The first elastic connecting plate 142 for electrical connection to the electrode terminal of the unit battery cell 10 in a pressurized state may protrude at (or from) opposite sides of a first cell bus bar 144.

Because the first elastic connecting plate 142 is installed in a bent state at the opposite sides of the first cell bus bar 144, the first elastic connecting plate 142 contacts the electrode terminals of the unit battery cells 10 in a pressurized state so that more a stable electrical connection is achieved.

The first elastic connecting plate 142 may include a first elastic piece 142a protruding from one side of the first cell bus bar 144 and a second elastic piece 142b protruding from the other (e.g., the opposite) side of the first cell bus bar 144.

The first elastic piece 142a may be formed of a metal material that has an elastic force and is electrically connected to the electrode terminal of the unit battery cell 10 and may protrude in a bent state at one side of the first cell bus bar 144.

When the first elastic piece 142a is in contact with the electrode terminals 11 and 13 of the unit battery cell 10, the first elastic piece 142a may be in close contact with the electrode terminals 11 and 13 by elastic deformation.

The elastic protrusion 46 may protrude at a portion where the first elastic piece 142a and the electrode terminal of the unit battery cell 10 contact each other.

The elasticity protrusion 46 may protrude on (or from) a surface of the first elastic piece 142a, and the plurality of elastic protrusions 46 may protrude at a portion where the first elastic piece 142a and the electrode terminal of the unit battery cell 10 contact each other.

Therefore, because the electrode terminals 11 and 13 of the unit battery cell 10 are stably in close contact with the elastic protrusion 46, the durability of electrical connection therebetween is improved.

The second elastic piece 142b may be formed of a metal material that has an elastic force and is electrically connected to the electrode terminal of the unit battery cell 10 and may protrude in a bent state at (or from) the other side of the first cell bus bar 14.

For example, the second elastic piece 142b may protrude in a bent state at a position opposite to a position where the first elastic piece 142a is installed with the first cell bus bar 144 interposed between the second elastic piece 142b and the first elastic piece 142a.

Therefore, when the second elastic piece 142b is in contact with the electrode terminals 11 and 13 of the unit battery cell 10, the second elastic piece 142b may be in close contact with the electrode terminals 11 and 13 by elastic deformation.

The elastic protrusion 46 may protrude at a portion where the second elastic piece 142b and the electrode terminal of the unit battery cell 10 contact each other.

The elasticity protrusion 46 may protrude on (or from) a surface of the second elastic piece 142b, and the plurality of elastic protrusions 46 may protrude at a portion where the second elastic piece 142b and the electrode terminal of the unit battery cell 10 contact each other.

For example, because the first elastic piece 142a and the second elastic piece 142b of the third embodiment have the same size and the same shape and protrude in a bent state at both sides of the first cell bus bar 144, the plurality of unit battery cells 10 may be electrically connected to each other.

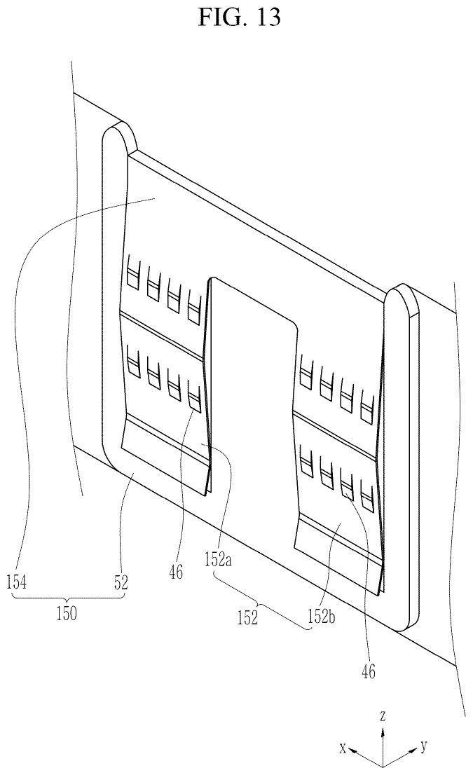

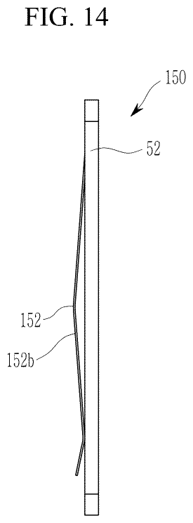

FIG. 13 is a view schematically showing a state in which a second elastic connecting plate protrudes at a second holder of the battery holder of the rechargeable battery pack according to the third embodiment of the present disclosure, and FIG. 14 is a side view schematically showing a state in which the second elastic connecting plate protrudes at a side surface of the second holder of FIG. 13. In the following description, the same reference numerals as those in FIGS. 1 to 12 denote the same or similar element of component having the same or similar function. Thus, detailed description of elements or components denoted by the same reference numeral will be omitted.

As shown in FIGS. 13 and 14, a second holder 150 may include the second holder body 52 and a second cell bus bar 154 inserted into the second holder body 52. The second elastic connecting plate 152 may protrude at the second cell bus bar 154.

The second elastic connecting plate 152 may be installed at one side of the second cell bus bar 154 to be electrically connected to the different electrode terminals of the plurality of unit battery cells 10 in a pressurized state so that the plurality of unit battery cells 10 are connected in the second direction (e.g., the x-axis direction).

The second elastic connecting plate 152 may include a first connecting plate 152a electrically connected to an electrode terminal of one unit battery cell from among the plurality of unit battery cells 10 and a second connecting plate 152b electrically connected to an electrode terminal of the other unit battery cell from among the plurality of unit battery cells 10.

The first connecting plate 152a may be formed at one side of the second elastic connecting plate 152 and may be electrically connected to one electrode terminal of a pair of unit battery cells 10 to be electrically connected to each other.

The second connecting plate 152b may be formed at the other side of the second elastic connecting plate 152 and may be electrically connected to the other electrode terminal of the pair of unit battery cells 10 to be electrically connected to each other.

For example, the first connecting plate 152a and the second connecting plate 152b may be formed adjacent to the second cell bus bar 154 to connect electrode terminals of different polarities of the pair of unit battery cells 10 to each other in the second direction (e.g., the x-axis direction).

The elastic protrusion 46 may protrude at (or from) each of the first connecting plate 152a and the second connecting plate 152b.

For example, the plurality of elastic protrusions 46 may protrude from surfaces of the first connecting plate 152a and the second connecting plate 152b and may protrude so that the electrode terminal of the unit battery cell 10 is more easily electrically connected.

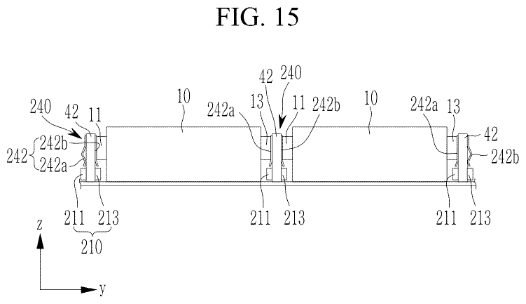

FIG. 15 is a side view schematically illustrating a state in which a guide rib protrudes at a battery holder of a rechargeable battery pack according to a fourth embodiment of the present disclosure. In the following description, the same reference numerals as those used in FIGS. 1 to 14 denote the same or similar elements or components having the same or similar function. Thus, detailed description of elements or components denoted by the same reference numeral will be omitted.

As shown in FIG. 15, the guide rib 210 may protrude on a side surface of a first holder 240 of the battery holder of the rechargeable battery pack according to the fourth embodiment of the present disclosure.

The guide rib 210 may prevent an insertion error from occurring in a process of inserting and fixing the plurality of unit battery cells 10 into the first holder 240 and may protrude on the side surface of the first holder 240.

The guide rib 210 may include a first rib 211 protruding at one side of the first cell bus bar 44 and a second rib 213 protruding at the other side of the first cell bus bar 44.

The first rib 211 may protrude at the one side of the first cell bus bar 44 and may prevent an insertion error of the unit battery cell 10 inserted from the one side of the first cell bus bar 44 from occurring.

The second rib 213 may protrude to the other side of the first cell bus bar 44 and may prevent an insertion error of the unit battery cell 10 inserted from the other side of the first cell bus bar 44 from occurring.

The first rib 211 and the second rib 213 may protrude at a lower position of the first cell bus bar 44 and may protrude on a side surface of the first cell bus bar 44 without contacting the first elastic piece 242a and the second elastic piece 242b.

To this end, one side of each of the first elastic piece 242a and the second elastic piece 242b may be connected to an upper side of the first cell bus bar 44, and the other side of each of the first elastic piece 242a and the second elastic piece 242b may extend to a lower portion of the first cell bus bar 44 so that a portion of the side surface of the first cell bus bar 44 is exposed to the outside.

An elastic piece 242 may include the first elastic piece 242a protruding at both sides of the first holder body 42 and the second elastic piece 242b.

For example, the first elastic piece 242a and the second elastic piece 242b may be formed with the same length in up and down (vertical) directions at opposite sides of the first cell bus bar 44 and may be formed with a length shorter than a height of the first cell bus bar 44. Thus, a portion of a surface of the first cell bus bar 44 may be exposed to the outside so that the guide rib 210 protrudes.

Therefore, because each of the first rib 211 and the second rib 213 protrudes at an exposed portion of the first cell bus bar 44 where the first elastic piece 142a and the second elastic piece 142b are not disposed, an insertion position of the unit battery cell 10 may be guided.

For example, because the electrode terminals 11 and 13 of the unit battery cell 10 may protrude at an upper eccentric position with respect to a center of the unit battery cell 10 in the fourth embodiment, the electrode terminals 11 and 13 may interfere with the first rib 211 or the second rib 213 if an error occurs in inserting the unit battery cell 10 into the battery holder 30.

Therefore, the unit battery cell 10 may be inserted in a correct position between first holders 240 of the battery holder by an insertion guide action of the guide rib 210 so that the insertion error of the unit battery cell 10 is prevented from occurring.

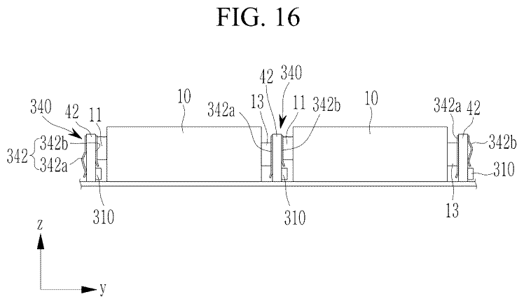

FIG. 16 is a side view schematically illustrating a state in which a guide rib protrudes at a battery holder of a rechargeable battery pack according to a fifth embodiment of the present disclosure. In the following description, the same reference numerals as those used in FIGS. 1 to 15 denote the same or similar elements or components having the same or similar function. Thus, detailed descriptions of the elements or components denoted by the same reference numeral will be omitted.

As shown in FIG. 16, in a first holder 340 of the battery holder of the rechargeable battery pack according to the fifth embodiment of the present disclosure, a single guide rib 310 may protrude on (or may protrude from) one side surface of the first cell bus bar 44.

To this end, an elastic piece 342 may include a first elastic piece 342a and a second elastic piece 342b.

One of the first elastic piece 342a and the second elastic piece 342b may be formed with a length shorter than a height of the first cell bus bar 44 so that a portion of a surface of one side of the first cell bus bar 44 is exposed to the outside.

For example, the single guide rib 310 may protrude at an exposed portion of the first cell bus bar 44 where the elastic piece is not disposed on the one side surface of the first cell bus bar 44.

The first electrode terminal 11 of the unit battery cell 10 in the fifth embodiment may protrude at an eccentric position (e.g., a central axis of the first electrode terminal 11 may be offset from a central axis or center plane of the unit battery cell) on one side of the unit battery cell while the second electrode terminal 13 thereof may protrude at a central position of the other side of the unit battery cell. The first electrode terminal 11 and the second electrode terminal 13 may respectively protrude at different height positions at both sides of the unit battery cell 10.

Therefore, in a process of inserting the unit battery cell 10 of the fifth embodiment between the battery holders 30, the unit battery cell 10 electrically connected to the elastic piece may be inserted in a correct position in a state in which the first electrode terminal 11 is disposed at an upper side of the guide rib 310.

For example, if an error occurs when the unit battery cell 10 of the fifth embodiment is inserted between first holders 340, the first elastic piece 142a may interfere with the first electrode terminal 11 so that the insertion error is prevented from occurring.

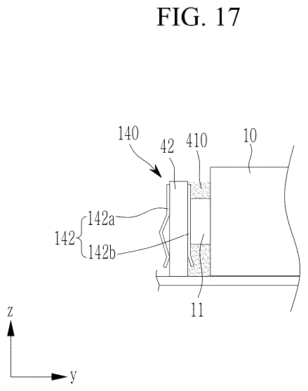

FIG. 17 is a view schematically showing a state in which an electrical conductivity filler is applied between a battery holder and an electrode terminal according to a sixth embodiment of the present disclosure. In the following description, the same reference numerals as those used in FIGS. 1 to 16 denote the same or similar elements or components having the same or similar function. Thus, detailed descriptions of elements or components denoted by the same reference numeral will be omitted.

As shown in FIG. 17, in the rechargeable battery pack 100 according to the fifth embodiment of the present disclosure, the electrical conductivity filler 410 may be applied between the battery holder and the electrode terminal 11 or 13. It is illustrated that the electrical conductivity filler 410 is applied between the first holder body 42 of the first holder 140 and the first electrode terminal 11, but the electrical conductivity filler 410 may be further applied between the second holder 50 and the second electrode terminal 13.

The electrical conductivity filler 410 may be filled between the electrode terminal 11 or 13 of the unit battery cell 10 and the first elastic connecting plate 142 of the battery holder 30 and may reduce a contact resistance between the electrode terminal 11 or 13 and the unit battery cell 10.

The electrical conductivity filler 410 may be applied in a form of a paste between the electrode terminal and the unit battery cell and may be a solder or a conductive glue film (or a conductive adhesive film).

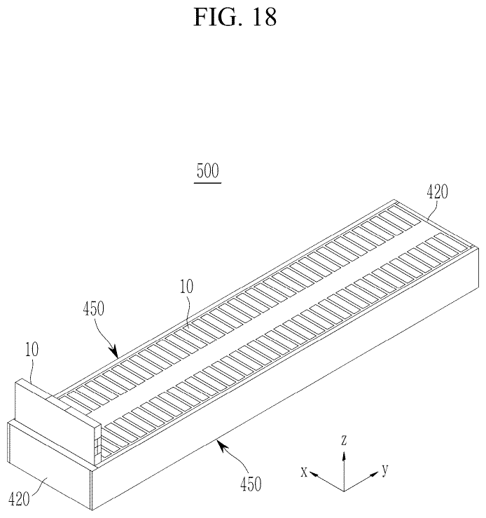

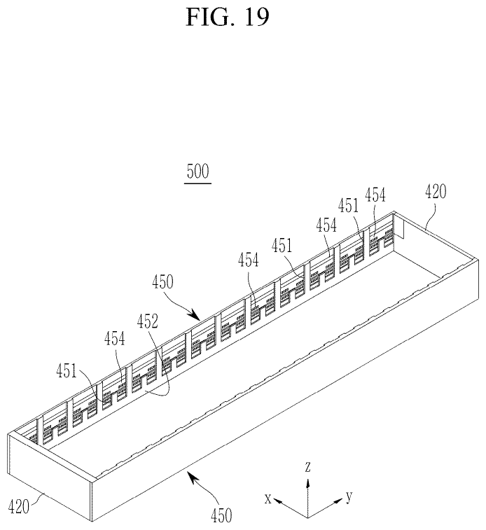

FIG. 18 is a perspective view schematically showing a rechargeable battery pack according to the sixth embodiment of the present disclosure, and FIG. 19 is a perspective view schematically showing a state in which a unit battery cell is removed from the rechargeable battery pack shown in FIG. 18. In the following description, the same reference numerals as used in FIGS. 1 to 17 denote the same or similar elements or components having the same or similar function. Thus, detailed descriptions of elements or components denoted by the same reference numerals will be omitted.

As shown in FIGS. 18 and 19, a battery holder (e.g., a third battery holder) 450 of a rechargeable battery pack 500 according to the sixth embodiment of the present disclosure may include a third holder 450 installed at both sides opposite to inner wall surfaces of a case 420 to electrically connect the plurality of unit battery cells. Hereinafter, the battery holder and the third holder use the same reference number for convenience of description.

The third holder 450 may include a third holder body 452 having a plurality of third insertion portions 451 formed therein and installed at opposite sides of the inner wall surfaces of the case 420 and a plurality of third cell bus bars 454 inserted into the plurality of third insertion portions 451 of the third holder body 452 and connected to the electrode terminal of the unit battery cell 10.

The third holder body 452 may be installed at the opposite sides of the case 420 and may have the plurality of third insertion portions 451 formed along a length direction.

The plurality of third cell bus bars 454 may be installed in the plurality of third insertion portions 451 to electrically connect the plurality of unit battery cells 10 to each other.

The elastic protrusion 46 electrically connected to the electrode terminal 11 or 13 of the unit battery cell 10 may protrude from a surface of the third cell bus bar 454.

While the present disclosure has been described in connection with what is presently considered to be practical embodiments, it is to be understood that the present disclosure is not limited to the disclosed embodiments. On the contrary, the present disclosure is intended to cover various modifications and equivalent arrangements included within the scope of the appended claims and their equivalents.

What is claimed is:

1. A rechargeable battery pack comprising:
a plurality of unit battery cells;
a case having an insertion space, the plurality of unit battery cells being accommodated in the insertion space; and
a plurality of battery holders installed inside the case and electrically connecting the plurality of unit battery cells to each other.

2. The rechargeable battery pack as claimed in claim 1, wherein the plurality of battery holders are installed inside the case along a first direction.

3. The rechargeable battery pack as claimed in claim 2, wherein the battery holder comprises:
a first holder that connects the plurality of unit battery cells to each other in the first direction in the insertion space of the case; and
a second holder that connects the plurality of unit battery cells in a second direction orthogonal to the first direction at one side of the case.

4. The rechargeable battery pack as claimed in claim 3, wherein each of the first holders comprises:
a plurality of first holder bodies spaced apart from each other at equal intervals, the plurality of first holder bodies each have a first insertion portion extending in a longitudinal direction; and
a plurality of first cell bus bars respectively in the plurality of first insertion portions,
wherein electrode terminals of the plurality of unit battery cells being are connected to ones of the first cell bus bars at opposite sides of the plurality of first holder bodies.

5. The rechargeable battery pack as claimed in claim 4, wherein the second holder comprises:
a second holder body installed at one side of an inner wall surface of the case and having a plurality of second insertion portions extending in a length direction; and
a plurality of second cell bus bars respectively in the plurality of second insertion portions and electrically connected to different electrode terminals of the plurality of unit battery cells.

6. The rechargeable battery pack as claimed in claim 5, wherein each of the first cell bus bars has an elastic protrusion protruding from a surface thereof and electrically connected to the electrode terminal of one of the plurality of unit battery cells.

7. The rechargeable battery pack as claimed in claim 6, wherein each of the plurality of second cell bus bars has an elastic protrusion protruding from a surface thereof and electrically connected to the electrode terminal of one of the plurality of unit battery cells.

8. The rechargeable battery pack as claimed in claim 7, each of the plurality of first cell bus bars further comprises a first elastic connecting plate protruding at opposite sides of corresponding one of the first cell bus bars and electrically connected to the electrode terminal of one of the unit battery cells in a pressurized state.

9. The rechargeable battery pack as claimed in claim 8, wherein the first elastic connecting plate comprises:
a first elastic piece protruding from one side of the corresponding first cell bus bar; and
a second elastic piece protruding from the other side of corresponding the first cell bus bar.

10. The rechargeable battery pack as claimed in claim 9, wherein the elastic protrusion protrudes from a surface of the first elastic connecting plate.

11. The rechargeable battery pack as claimed in claim 10, wherein each of the second holder further comprises a second elastic connecting plate installed at one side of the second cell bus bar and electrically connected to different electrode terminals of ones of the plurality of unit battery cells in a pressurized state.

12. The rechargeable battery pack as claimed in claim 11, wherein the second elastic connecting plate comprises:
a first connecting plate electrically connected to an electrode terminal of one unit battery cell from among the plurality of unit battery cells; and
a second connecting plate electrically connected to an electrode terminal of another unit battery cell from among the plurality of unit battery cells.

13. The rechargeable battery pack as claimed in claim 12, wherein the elastic protrusion protrudes from the surface of the first elastic connecting plate and from a surface of the second elastic connecting plate.

14. The rechargeable battery pack as claimed in claim 13, wherein at least one of the battery holders comprises a guide rib protruding from a side surface of the at least one of the battery holders and being configured to guide a position at where the unit battery cell is inserted into the at least one of the battery holders.

15. The rechargeable battery pack as claimed in claim 14, wherein at least one of the first elastic piece and the second elastic piece has a length that is shorter than a height of the corresponding first cell bus bar such that a portion of the first cell bus bar is exposed to the outside.

16. The rechargeable battery pack as claimed in claim 15, wherein the first elastic piece and the second elastic piece have the same length in a vertical direction at opposite sides of the corresponding first cell bus bar.

17. The rechargeable battery pack as claimed in claim 16, wherein each of the first elastic piece and the second elastic piece has a length that is shorter than the height of the cell bus bar such that portions of surfaces of the opposite sides of the cell bus bar are exposed to the outside.

18. The rechargeable battery pack as claimed in claim 17, wherein the guide rib comprises:
a first rib protruding at an exposed portion of the cell bus bar and on one side surface of the cell bus bar; and
a second rib protruding at an exposed portion of the cell bus bar and on the other side surface of the cell bus bar.

19. The rechargeable battery pack as claimed in claim 18, wherein the first rib and the second rib protrude at the same height position at the opposite sides of the corresponding first cell bus bar.

20. The rechargeable battery pack as claimed in claim 19, wherein the electrode terminals of the unit battery cell comprise:
a first electrode terminal protruding at an eccentric position from one side of the unit battery cell; and
a second electrode terminal protruding at an eccentric position from another side of the unit battery cell,
wherein the first electrode terminal and the second electrode terminal protrude at the same height position on both sides of the unit battery cell.
